(19) United States
(12) Patent Application Publication
(10) Pub. No.: US 2026/0210286 A1
(43) Pub. Date: Jul. 23, 2026

(54) TWO-STROKE ENGINE AND HANDHELD WORK APPARATUS

(71) Applicant: Andreas Stihl AG & Co. KG, Waiblingen (DE)

(72) Inventors: Jan Kurzenberger, Köngen (DE); Robert Köhli, Winnenden (DE); Mark Reichler, Remshalden (DE); Niels Kunert, Ottenbach (DE); Dante Wagner Fritzen, Conoas (BR)

(21) Appl. No.: 19/457,001

(22) Filed: Jan. 22, 2026

(30) Foreign Application Priority Data
Jan. 23, 2025 (DE) 10 2025 102 477.4

(51) Int. Cl. F02B 25/18; F02B 63/02; F02B 75/02

(52) U.S. Cl. CPC F02B 25/18; F02B 63/02; F02B 75/02; F02B 2075/025

(57) ABSTRACT

A two-stroke engine includes a cylinder with a cylinder bore. A crankshaft is mounted in a crankcase so as to be rotatable about a rotational axis. An intake channel over at least part of its length is divided into at least one mixture and at least one air channel. When viewed in a direction parallel to the rotational axis of the crankshaft, the mixture and the air channel downstream of a fuel supply unit are, at least over one section, curved. The mixture channel, when viewed parallel to the rotational axis of the crankshaft, downstream of the fuel supply unit to a spacing of 5 mm from the bore runs exclusively straight or performs a right-hand bend. The air channel, when viewed in the same direction, downstream of the fuel supply unit up to a spacing of 5 mm from the bore runs exclusively straight or performs a left-hand bend.

### CROSS-REFERENCE TO RELATED APPLICATIONS

This application claims priority of German patent application no. 10 2025 102 477.4, filed January 23, 2025, the entire content of which is incorporated herein by reference.

### BACKGROUND

Known from US 2007/0272188 is a two-stroke engine which has a mixture channel and an air channel. The mixture channel and the air channel open out at the cylinder bore. The mixture channel and the air channel are guided in an intake channel which is divided downstream of a carburetor into the mixture channel and the air channel. The mixture channel is guided in the carburetor so as to be on the side of the air channel that is close to the cylinder and opens out at the cylinder on the side of the air channel that is close to the crankcase. When viewed parallel to the rotational axis of the crankshaft, the air channel and the mixture channel therefore have to cross one another between the carburetor and the cylinder.

### SUMMARY

It is an object of the disclosure to provide a two-stroke engine which has a positive operating behavior. A further object of the disclosure lies in providing a handheld work apparatus which has a positive operating behavior.

In terms of the two-stroke engine, this object is, for example, achieved by a two-stroke engine including a piston; a cylinder with a cylinder bore in which the piston is mounted so as to reciprocate; the piston delimiting a combustion chamber formed in the cylinder; a crankcase defining a crankcase interior; a crankshaft mounted in the crankcase so as to be rotatable about a rotational axis and configured to be rotatingly driven by the piston; an intake channel; a fuel supply unit in which at least one section of the intake channel is formed, the intake channel having an intake channel length; the intake channel over at least part of the intake channel length being divided into at least one mixture channel and at least one air channel; the at least one mixture channel opens into the crankcase interior via at least one mixture channel opening; at least one transfer channel which in the region of a bottom dead center of the piston fluidically connects the crankcase interior to the combustion chamber; the at least one transfer channel opening out at the cylinder bore via at least one transfer window; the at least one air channel opening out at the cylinder bore via at least one air channel opening; the piston having at least one piston pocket; wherein the at least one air channel opening, in at least one position of the piston, is connected via the at least one piston pocket to the at least one transfer window of the at least one transfer channel; wherein when viewed in a direction parallel to the rotational axis of the crankshaft, downstream of the fuel supply unit, the at least one mixture channel and the at least one air channel are formed to be curved over at least one section of a respective length thereof; the at least one mixture channel, when viewed in the direction parallel to the rotational axis of the crankshaft, downstream of the fuel supply unit up to a first spacing of 5 millimeters from the cylinder bore running exclusively straight or performing a right-hand bend; and, the at least one air channel, when viewed in the direction parallel to the rotational axis of the crankshaft, downstream of the fuel supply unit up to a second spacing of 10 millimeters from the cylinder bore running exclusively straight or performing a left-hand bend.

In terms of the handheld work apparatus, this object is, for example, achieved by a handheld work apparatus including a two-stroke engine including a piston, a cylinder, a crankcase, a crankshaft, and an intake channel; the cylinder having a cylinder bore in which the piston is mounted so as to reciprocate; the piston delimiting a combustion chamber formed in the cylinder; the crankcase defining a crankcase interior; the crankshaft being mounted in the crankcase so as to be rotatable about a rotational axis and configured to be rotatingly driven by the piston; the intake channel having a fuel supply unit in which at least one section of the intake channel is formed, the intake channel having an intake channel length; the intake channel over at least part of the intake channel length being divided into at least one mixture channel and at least one air channel; the at least one mixture channel opening into the crankcase interior via at least one mixture channel opening; the two-stroke engine further including at least one transfer channel which in the region of a bottom dead center of the piston fluidically connects the crankcase interior to the combustion chamber; the at least one transfer channel opens out at the cylinder bore via at least one transfer window; the at least one air channel opens out at the cylinder bore via at least one air channel opening; the piston having at least one piston pocket; wherein the at least one air channel opening, in at least one position of the piston, is connected via the at least one piston pocket to the at least one transfer window of the at least one transfer channel; wherein when viewed in a direction parallel to the rotational axis of the crankshaft, downstream of the fuel supply unit, the at least one mixture channel and the at least one air channel are formed to be curved over at least one section of a respective length thereof; the at least one mixture channel, when viewed in the direction parallel to the rotational axis of the crankshaft, downstream of the fuel supply unit up to a first spacing of 5 millimeters from the cylinder bore running exclusively straight or performing a right-hand bend; and, the at least one air channel, when viewed in the direction parallel to the rotational axis of the crankshaft, downstream of the fuel supply unit up to a second spacing of 10 millimeters from the cylinder bore running exclusively straight or performing a left-hand bend.

It has been demonstrated that the deflection of the mixture channel and of the air channel necessitated by the crossing of the mixture channel and the air channel can lead to flow losses in particular in the air channel, and to an insufficient supply of air. In order to minimize these flow losses, it is provided that the mixture channel, when viewed in a direction parallel to the rotational axis of the crankshaft, downstream of the fuel supply unit up to a spacing of 5 mm from the cylinder bore runs exclusively straight or performs a right-hand bend. The air channel, when viewed in the same direction, downstream of the fuel supply unit up to a spacing of 10 mm from the cylinder bore performs exclusively a left-hand bend or runs straight. Accordingly, when viewed in the direction parallel to the rotational axis of the crankshaft, the mixture channel and the air channel run in opposite directions and are curved in only one direction in the region. The spacing from the cylinder bore is in each case measured perpendicularly to the wall of the cylinder bore, so as to proceed from the mixture channel opening or the air channel opening, respectively. In the section which lies directly upstream of the mixture channel opening, or upstream of the air channel opening, respectively, the mixture channel or the air channel can thus be bent in a different direction. It can be provided that the air channel and/or the mixture channel run straight over a section of their length downstream of the fuel supply unit, when viewed in the direction.

Owing to the curvature being only in one direction, multiple deflections of the flow are avoided, and flow losses can be reduced. The mixture channel and the air channel here are configured to be curved over at least a section of their length downstream of the fuel supply unit, when viewed in the direction.

In particular, in a position of the two-stroke engine in which the cylinder longitudinal axis is vertical and the crankcase is disposed below the combustion chamber, the mixture channel is bent downwards towards the cylinder. In particular, in a position of the two-stroke engine in which the cylinder longitudinal axis is vertical and the crankcase is disposed below the combustion chamber, the air channel is bent upwards towards the cylinder.

The fuel supply unit is connected to the cylinder by way of a connecting port which has an upstream flange surface. In particular, the upstream flange surface bears at least partially on the fuel supply unit.

In particular, the fuel supply unit has a throttle element which controls the air channel and the mixture channel. In particular, the two-stroke engine has an intake channel longitudinal axis. The intake channel longitudinal axis intersects a pivot axis of the throttle element centrically and perpendicularly in that cross section of the intake channel in which the pivot axis lies, and runs perpendicularly to the upstream flange surface.

The at least one mixture channel opening is divided by an imaginary plane, which runs perpendicularly to a cylinder axis, into a first region and into a second region. The second region is further away from the combustion chamber than the first region. The imaginary plane is disposed in such a manner that a height of the first region, measured parallel to the cylinder longitudinal axis, is at least two times a height of the second region, measured parallel to the cylinder longitudinal axis. The intake channel longitudinal axis intersects the at least one mixture channel opening in particular in the first region.

In particular, the intake channel longitudinal axis is inclined relative to the cylinder longitudinal axis by an angle deviating from 90º. An angle between the upstream flange surface and the cylinder longitudinal axis is in particular 30º to 70º, in particular 40º to 60º. The angle is exactly the same size as an angle between the intake channel longitudinal axis and the cylinder longitudinal axis.

The connecting port has a passage opening in which the intake channel is guided. The passage opening widens in particular to a greater extent in the direction towards the upstream flange surface than in the direction towards the downstream flange surface. As a result, a geometry of the connecting port which is favorable for demolding the connecting port using extracted cores in the production of the connecting port by an injection-molding method can be achieved.

In particular, the two-stroke engine has an impulse channel. The impulse channel connects the crankcase interior to the fuel supply unit, in particular to a fuel pump of the fuel supply unit. The impulse channel runs in particular through the upstream flange surface and through the downstream flange surface. In particular, the impulse channel runs through a connecting flange of the crankcase, on which the cylinder is connected to the crankcase.

The mixture channel opening has a height, measured parallel to the cylinder longitudinal axis. In particular, the mixture channel has an upper edge proximal to the combustion chamber and a lower edge distal from the combustion chamber. A first width of the mixture channel opening, measured at a spacing of 15% of the height of the mixture channel opening from the upper edge of the mixture channel opening, is in particular larger than a second width of the mixture channel opening. The second width of the mixture channel opening is measured at a spacing of 15% of the height of the mixture channel opening from the lower edge of the mixture channel opening. In particular, the first width is at least 1.05 times the second width. The width of the mixture channel opening is measured in each case in a plane running perpendicularly to the cylinder longitudinal axis.

The mixture channel opening has in particular at least one side wall which interconnects the upper edge and the lower edge of the mixture channel opening. In a central section of the side wall, which extends at a spacing of 15% of the height from the upper edge to a spacing of 15% of the height from the lower edge, the at least one side wall runs straight. Accordingly, the central section defines a region which has a spacing of in each case 15% of the height of the mixture channel opening from the upper edge and from the lower edge. In particular, the mixture channel opening has two mutually opposite side walls that run straight in the central section mentioned. The central section takes into account that the regions of the mixture channel opening in which the upper edge and the lower edge are connected to the side walls are usually of a radiused configuration, thus having a smaller width. In the non-radiused section of the side walls, the width of the mixture channel opening decreases in particular continuously from the first width towards the second width.

In particular, the mixture channel opening runs so as to be mirror symmetrical to a symmetry plane running parallel to the cylinder longitudinal axis.

In particular, the cylinder has an outlet channel which adjoins an outlet opening from the combustion chamber. A width of the outlet channel is measured in a section plane perpendicular to the cylinder longitudinal axis. Proceeding from the outlet opening, the width of the outlet channel decreases in particular by at least 25%. A height of the outlet channel, measured parallel to the cylinder longitudinal axis in a plane containing the cylinder longitudinal axis, proceeding from the outlet opening increases in particular by at least 50%. Accordingly, proceeding from the cylinder bore, the outlet channel becomes narrower and higher as the spacing from the cylinder bore increases. This results in a favorable arrangement.

In a position of the two-stroke engine in which the cylinder longitudinal axis is vertical and the crankcase is disposed below the combustion chamber, the mixture channel in the fuel supply unit runs in particular at least partially above the air channel. In a two-stroke engine in which the mixture channel in the mixture supply unit runs at least partially above the air channel when in the position, the air channel and the mixture channel usually cross one another between the mixture supply unit and the cylinder, resulting in severe deflections of the flow. The configuration of the air channel and mixture channel stated is advantageous in particular for a two-stroke engine of this type.

A handheld work apparatus with a two-stroke engine is in particular a chain saw or an angle grinder.

### BRIEF DESCRIPTION OF DRAWINGS

The invention will now be described with reference to the drawings wherein:

FIG. 1 shows a schematic longitudinal section through a chain saw with a two-stroke engine;

FIG. 2 shows details of the illustration in FIG. 1 in the region of the cylinder and crankcase of the two-stroke engine;

FIG. 3 shows details of the illustration in FIG. 1 in the region of the fuel supply unit and connecting port of the two-stroke engine;

FIG. 4 shows a section through the cylinder of the two-stroke engine in a section plane perpendicular to the cylinder longitudinal axis;

FIG. 5 shows a schematic illustration of the intake channel with the air channel and mixture channel, wherein only the cavities are illustrated, when viewed in a direction parallel to the pivot axis of the throttle element;

FIG. 6 shows a perspective illustration of the intake channel, the mixture channel and the air channel, in an illustration of the cavities corresponding to FIG. 5;

FIG. 7 shows a developed view of the cylinder bore and piston of the two-stroke engine; and,

FIG. 8 shows an enlarged illustration of the developed view of the mixture channel opening of the two-stroke engine.

### DETAILED DESCRIPTION

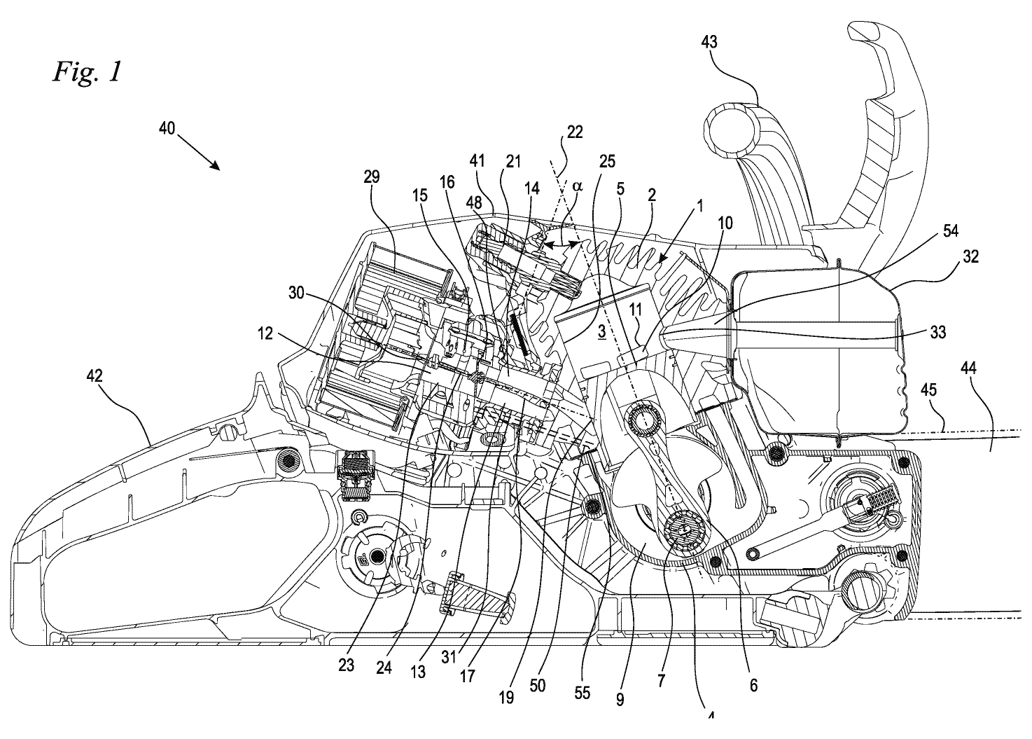

FIG. 1 schematically shows a section through a handheld work apparatus, the latter in the embodiment being a chain saw 40. In an alternative configuration, the handheld work apparatus can also be an angle grinder. The chain saw 40 has a housing 41 on which are fixedly established a rear handle 42 and a bail handle 42. A guide bar 44 on which a saw chain 45 is disposed so as to revolve thereon is fixed to the housing 41. The saw chain 45 is driven by a two-stroke engine 1 of the chain saw 40.

The two-stroke engine 1 has a cylinder 2 in which a combustion chamber 3 is formed. The two-stroke engine 1 includes a crankcase 4 in which a crankshaft 7 is mounted so as to be rotatable about a rotational axis 8. The combustion chamber 3 is delimited by a piston 5 which drives the crankshaft 7 by way of a connecting rod 6. A crankcase interior 9 is fluidically connected to the combustion chamber 3 by way of at least one transfer channel 10. The transfer channel 10 opens into the combustion chamber 3 by way of one or a plurality of transfer windows 11.

The two-stroke engine 1 has an air filter 29 which is connected to the cylinder 2 by way of an intake channel 12. A section 23 of the intake channel 12 is guided in a fuel supply unit 15. In the embodiment, the fuel supply unit 15 is a carburetor. The fuel supply unit 15 has a throttle element 16 which controls the available flow cross section of the intake channel 12. The intake channel 12, at least downstream of the fuel supply unit 15, is divided into an air channel 13 and into a mixture channel 14. The intake channel 12 is at least over one section of its length divided into the air channel 13 and into the mixture channel 14 by a partition wall 17.

The throttle element 16 controls the mixture channel 14 as well as the air channel 13. In the embodiment, a choke element 30 is provided upstream of the throttle element 16.

The mixture channel 14 opens out at a cylinder bore 25 of the cylinder 2 by way of a mixture channel opening 19. The cylinder 2 has a cylinder longitudinal axis 22. A spark plug 21 protrudes into the combustion chamber 3. The intake channel 12 has an intake channel longitudinal axis 24 which intersects the mixture channel opening 19. An outlet opening 33, which by way of an outlet channel 54 formed in the cylinder 2 is connected to an exhaust muffler 32, leads out of the combustion chamber 3.

The fuel supply unit 15 is connected to the cylinder 2 by way of a connecting port 31. The air channel 13 and the mixture channel 14 are guided in the connecting port 31. An impulse channel 50 runs through the connecting port 31. The impulse channel 50 connects the fuel supply unit 15 to the crankcase interior 9. The impulse channel 50 is only schematically illustrated in FIG. 1 and runs outside the drawing plane in the wall of the connecting port 31 and of the cylinder 2. The impulse channel 50 opens out at a connecting flange 55 of the crankcase 4, at which the cylinder 2 is connected to the crankcase 4.

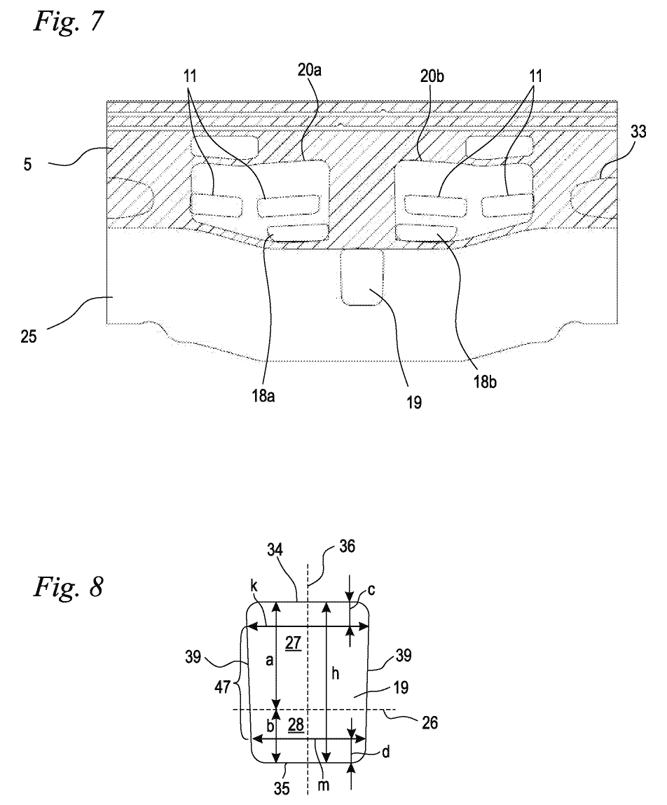

In the operation of the two-stroke engine 1, mixture is inducted into the crankcase interior 9 by way of the mixture channel 14 during the upwards stroke of the piston 5. Air from the air channel 13 is kept ready in the transfer channels 10, by way of piston pockets 20a, 20b of the piston 5 illustrated in FIG. 7. In the following downwards stroke of the piston 5, the fuel/air mixture is compressed in the crankcase interior 9 and flows into the combustion chamber 3 as soon as the transfer windows 11 open. In the following upwards stroke of the piston 5, the fuel/air mixture in the combustion chamber 3 is compressed in the combustion chamber 3 and ignited at the spark plug 21 in the region of the top dead center of the piston 5. During the downwards stroke of the piston 5, the outlet opening 33 opens first and exhaust gases flow out of the combustion chamber 3. The air kept ready in the transfer channels 10 first flows into the combustion chamber 3 by way of the transfer channels 10. Subsequently, a flow of fresh fuel/air mixture for the next engine cycle is resupplied from the crankcase interior 9 by way of the transfer channel 10.

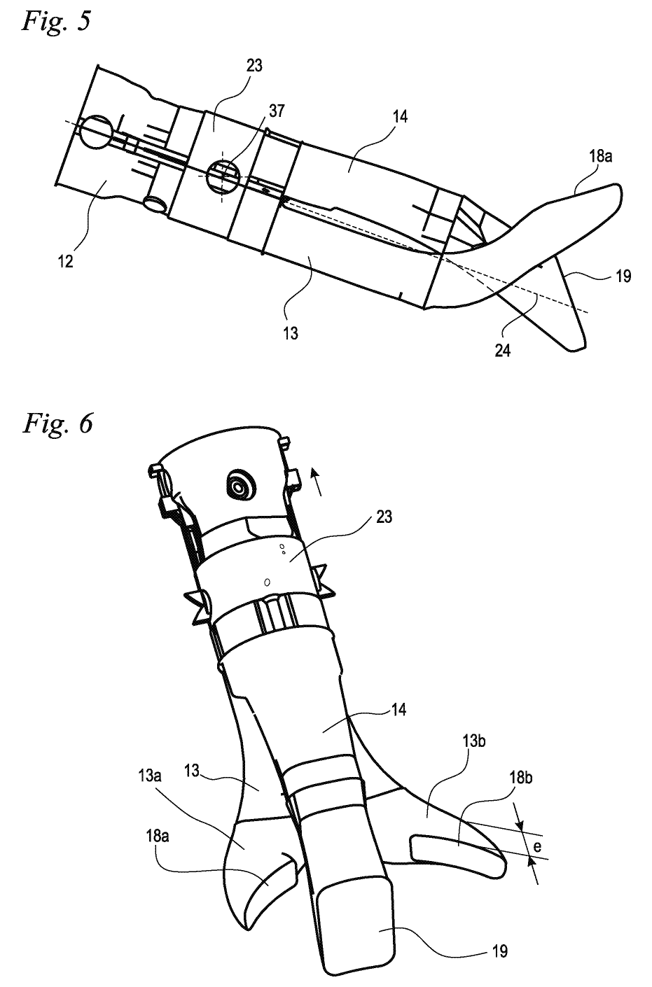

When viewed in the direction illustrated, the mixture channel 14 runs parallel to the rotational axis 8 of the crankshaft 7, and in an arrangement of the two-stroke engine 1 in which the fuel supply unit 15 is disposed to the left of the cylinder 2, downstream of the fuel supply unit 15 runs in a right-hand bend. When viewed in this direction, the air channel 13 runs in a left-hand bend, as shown in the illustration in FIG. 5. Accordingly, the air channel 13 and the mixture channel 14 run in opposite curves. In a section downstream of the fuel supply unit 15 up to a spacing f of 5 mm from the cylinder bore 25, the mixture channel 14 is curved only in a single direction of curvature. In a section downstream of the fuel supply unit 15 up to a spacing e of 10 mm from the cylinder bore 25, plotted in FIG. 6, the air channel 13 is curved only in a single direction of curvature. The spacings e and f are measured perpendicularly to the wall of the cylinder bore 25. The spacing e is measured up to the air channel opening 18a, 18b. The spacing f is measured up to the mixture channel opening 19.

As is shown in FIG. 1, in the fuel supply unit 15 the air channel 13 and the mixture channel 14 run in particular straight.

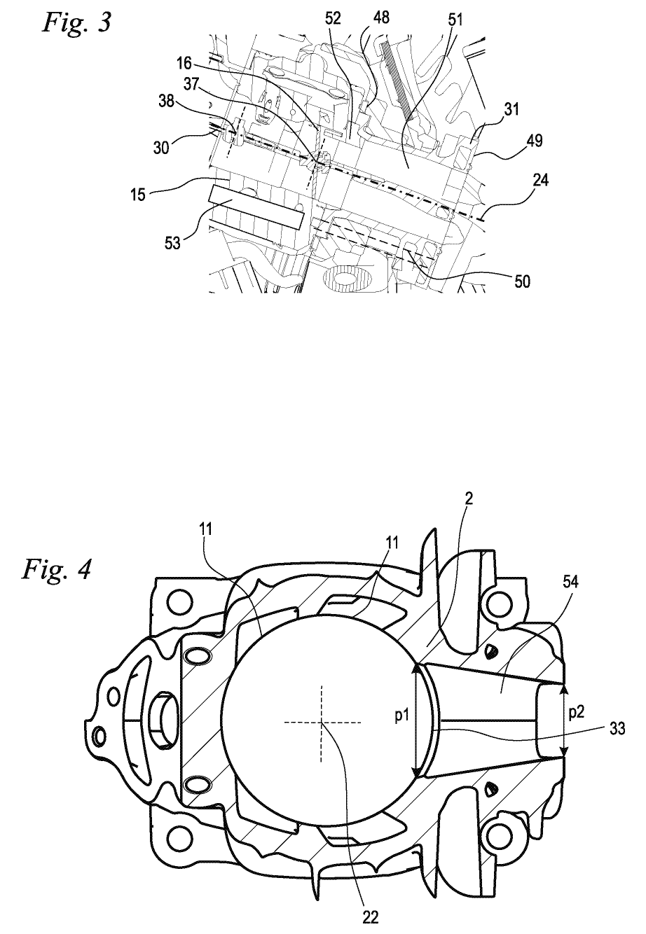

The intake channel longitudinal axis 24 is the axis which in the intake channel 12 centrically and perpendicularly intersects a pivot axis 37 (FIG. 5) of the throttle element 16 in that cross section of the intake channel 12 in which the pivot axis 37 lies. The intake channel longitudinal axis 24 runs perpendicularly to an upstream flange surface 48 (FIG. 1 and FIG. 3) of the connecting port 31. The upstream flange surface 48 of the connecting port 31 bears in particular at least partially on the fuel supply unit 15. The connecting port 31 has a downstream flange surface 49 which is likewise shown in FIG. 3 and bears in particular on the cylinder 2. The upstream flange surface 48 and the cylinder longitudinal axis 22 include an angle α plotted in FIG. 1. The angle α is in particular 30° to 70°, in particular 40° to 60º.

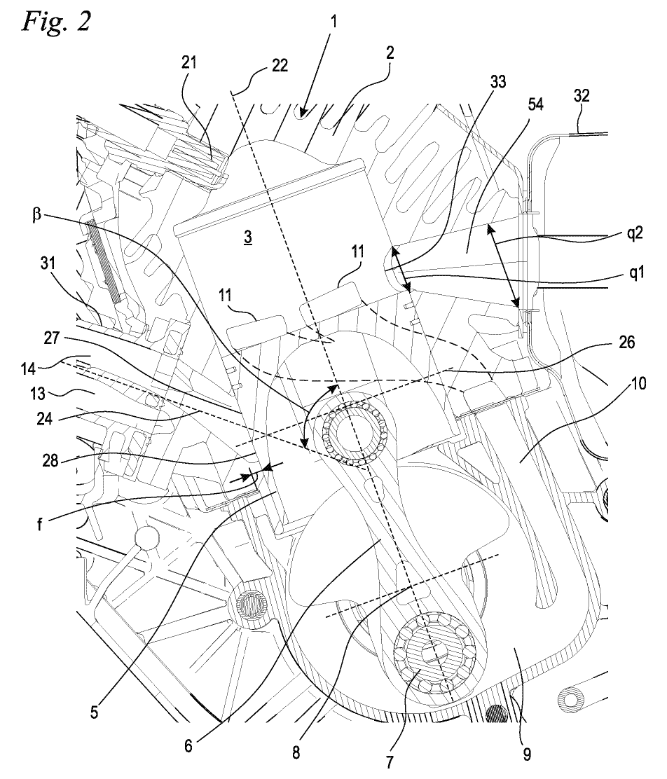

The two-stroke engine has a plane 26 which is plotted in FIG. 2. The plane 26 runs perpendicularly to the cylinder longitudinal axis 22 and intersects the mixture channel opening 19. As shown in FIG. 8, the plane 26 divides the mixture channel opening 19 into a first region 27, which is closer to the combustion chamber 3 (FIG. 2), and into a second region 28, which runs closer to the crankshaft 7 (FIG. 2) than the first region 27. The second region 28 is further away from the combustion chamber 3 than the first region 27. A height a of the first region 27, measured parallel to the cylinder longitudinal axis 22, is two times a height b of the second region 28, measured parallel to the cylinder longitudinal axis 22. The intake channel longitudinal axis 24 intersects the mixture channel opening 19 in the first region, as shown in FIG. 2. The intake channel longitudinal axis 24 intersects the mixture channel opening 19 in particular in the two thirds of the height of the mixture channel opening 19 that are close to the combustion chamber 3.

The mixture channel opening 19 has a height h measured parallel to the cylinder longitudinal axis 22.

As shown in FIG. 2, the intake channel longitudinal axis 24 and the cylinder longitudinal axis 22 include an angle β. The angle β is in particular 30° to 70°, in particular 40° to 60°.

As is shown in FIG. 1, in a position of the two-stroke engine 1 in which the cylinder longitudinal axis 22 is vertical and the crankcase 4 is disposed below the combustion chamber 3, the mixture channel 14 in the fuel supply unit 15 is disposed at least partially above the air channel 13. As a result, the air channel 13 and the mixture channel 13 cross one another when viewed in a direction parallel to the rotational axis 8 of the crankshaft 7.

In the position of the two-stroke engine 1 in which the cylinder longitudinal axis 22 is vertical and the crankcase 4 is disposed below the combustion chamber 3, the air channel 13 is bent upwards towards the cylinder 2. In a position of the two-stroke engine 1 in which the cylinder longitudinal axis 22 is vertical and the crankcase 4 is disposed below the combustion chamber 3, the mixture channel 14 is bent downwards towards the cylinder 2.

The at least one transfer channel 10 opens out at the cylinder bore 25 by way of the at least one transfer window 11. The mixture channel 14 as well as the air channel 13 are at least over a section of their length configured to be curved when viewed in the direction parallel to the rotational axis 8 of the crankshaft 7 illustrated in FIG. 1. In the embodiment, the air channel 13 and the mixture channel 14 run so as to be curved in the cylinder 2. The channels 13 and 14 also run so as to be already curved on a section of the connecting port 31, as shown in FIGS. 1 and 5.

The air channel 13 splits into the two branches 13a and 13b, as shown in FIG. 6. The branch 13a of the air channel 13 opens out at the cylinder bore 25 by way of an air channel opening 18a. The branch 13b of the air channel 13 opens out at the cylinder bore 25 by way of an air channel opening 18b. As is shown in FIG. 7, the piston 5 has the two piston pockets 20a and 20b. The air channel opening 18a is connected to two transfer windows 11 by way of the piston pocket 20a when the piston 5 is located in the region of its top dead center. The air channel opening 18b is connected to two transfer windows 11 by way of the piston pocket 20b when the piston 5 is located in its top dead center.

As is shown in FIG. 2, a height q of the outlet channel 54 increases when proceeding from the outlet opening 33. At the outlet opening, the outlet channel 54 has a height q1 measured parallel to the cylinder longitudinal axis 22. Close to the end of the outlet channel 54, the outlet channel 54 has a height q2 measured parallel to the cylinder longitudinal axis 22. The second height q2 is in particular at least 50% larger than the first height q1. Accordingly, the second height q2 is in particular 1.5 times, in particular 1.8 times, the first height q1.

FIG. 3 shows the configuration of the fuel supply unit 15 and of the connecting port 31. The fuel supply unit 15 has the fuel pump 53. The impulse channel 50 is in particular connected to the fuel pump 53.

The connecting port 31 has a passage opening 51 in which the air channel 13 and the mixture channel 14 are guided. The partition wall 17 can extend in the passage opening 51. The passage opening 51 widens to a greater extent at the upstream flange surface 48 than at the downstream flange surface 49. As a result, it is possible to de-mold the connecting port 31 despite the curved profile of the air channel 13 and of the mixture channel 14 already beginning in the connecting port 31. A connecting ring 52 which reduces the flow cross-section at the upstream flange surface 48 protrudes into the connecting port 31 at the upstream flange surface 48. The connecting port 31 is in particular fixed directly on the cylinder 2 at the downstream flange surface 49.

FIG. 4 shows a sectional illustration through the outlet opening 33, viewed perpendicularly to the cylinder longitudinal axis 22. The section plane here is at half the height of the outlet opening 33. Accordingly, the section plane from FIG. 4 intersects the outlet opening 33 in the sectional illustration illustrated in FIG. 2 centrically. As is shown in FIG. 4, the outlet channel 54 has at the outlet opening 33 a width p1 measured perpendicularly to the cylinder longitudinal axis 22. Proceeding from the outlet opening 33, the width p decreases to a second width p2. The width p2 is in particular at most 75% of the width p1.

FIG. 8 shows the configuration of the mixing channel opening 19 in detail. The mixing channel opening 19 has an upper edge 34 and a lower edge 35. The upper edge 35 and the lower edge 35 run in particular at least in one section in parallel planes perpendicular to the cylinder longitudinal axis 22. The upper edge 34 and the lower edge 35 are interconnected by way of two side walls 39. The mixture channel opening 19 has an approximately trapezoidal shape with radiused corners. The width of the trapezium on the side proximal to the combustion chamber 3 is larger than on the side distal from the combustion chamber 3. The upper edge 34 is the edge of the mixture channel opening 19 that is close to the combustion chamber 3, and the lower edge 35 is the edge of the mixture channel opening 19 that is remote from the combustion chamber 3.

A first width k of the mixture channel opening 19 is measured at a spacing c of 15% of the height h of the mixture channel opening 19 from the upper edge 34. A second width m of the mixture channel opening 19 is measured at a spacing d of 15% of the height h from the lower edge 35. The width k and the width m are measured in particular in regions of the mixture channel opening 19 in which the corners of the mixture channel opening 19 are not radiused. In particular, the widths m and k are measured between central sections 47 of the side walls 39. The central sections 47 extend in a region which has the spacing c of 15% of the height h from the upper edge 34 and the spacing d of 15% of the height h from the lower edge 35. The first width k of the mixture channel opening is larger than the second width m. The first width k is in particular at least 1.05 times the second width m.

The mixture channel opening 19 is in particular configured to be symmetrical to a symmetry plane 36 that contains the cylinder longitudinal axis 22.

It is understood that the foregoing description is that of the preferred embodiments of the invention and that various changes and modifications may be made thereto without departing from the spirit and scope of the invention as defined in the appended claims.

1. A two-stroke engine comprising:
a piston;
a cylinder with a cylinder bore in which said piston is mounted so as to reciprocate;
said piston delimiting a combustion chamber formed in said cylinder;
a crankcase defining a crankcase interior;
a crankshaft mounted in said crankcase so as to be rotatable about a rotational axis and configured to be rotatingly driven by said piston;
an intake channel;
a fuel supply unit in which at least one section of said intake channel is formed, said intake channel having an intake channel length;
said intake channel over at least part of said intake channel length being divided into at least one mixture channel and at least one air channel;
said at least one mixture channel opens into said crankcase interior via at least one mixture channel opening;
at least one transfer channel which in the region of a bottom dead center of said piston fluidically connects said crankcase interior to said combustion chamber;
said at least one transfer channel opening out at said cylinder bore via at least one transfer window;
said at least one air channel opening out at said cylinder bore via at least one air channel opening;
said piston having at least one piston pocket;
wherein said at least one air channel opening, in at least one position of said piston, is connected via said at least one piston pocket to said at least one transfer window of said at least one transfer channel;
wherein when viewed in a direction parallel to the rotational axis of said crankshaft, downstream of said fuel supply unit, said at least one mixture channel and said at least one air channel are formed to be curved over at least one section of a respective length thereof;
said at least one mixture channel, when viewed in the direction parallel to the rotational axis of said crankshaft, downstream of said fuel supply unit up to a first spacing of 5 millimeters from said cylinder bore running exclusively straight or performing a right-hand bend; and,
said at least one air channel, when viewed in the direction parallel to the rotational axis of said crankshaft, downstream of said fuel supply unit up to a second spacing of 10 millimeters from said cylinder bore running exclusively straight or performing a left-hand bend.

2. The two-stroke engine of claim 1, wherein said fuel supply unit is connected to said cylinder via a connecting port which has an upstream flange surface.

3. The two-stroke engine of claim 2, wherein said fuel supply unit has a throttle element configured to control said at least one air channel and said at least one mixture channel; and, the two-stroke engine has an intake channel longitudinal axis which intersects a pivot axis of said throttle element centrically and perpendicularly in a cross section of said intake channel in which the pivot axis lies and which runs perpendicularly to said upstream flange surface.

4. The two-stroke engine of claim 3, wherein said at least one mixture channel opening is divided, by an imaginary plane running perpendicularly to a cylinder longitudinal axis, into a first region and into a second region; said second region is further away from said combustion chamber than said first region; a first height of said first region, measured parallel to the cylinder longitudinal axis, is two times a second height of said second region measured parallel to the cylinder longitudinal axis; and, said intake channel longitudinal axis intersects said at least one mixture channel opening in said first region.

5. The two-stroke engine of claim 2, wherein an angle α between said upstream flange surface and a cylinder longitudinal axis is 30° to 70°.

6. The two-stroke engine of claim 2, wherein said connecting port has a passage opening in which said intake channel is guided; and said passage opening widens to a greater extent in a direction towards said upstream flange surface than in a direction towards a downstream flange surface.

7. The two-stroke engine of claim 1, wherein said at least one mixture channel opening has a mixture channel opening height, measured parallel to a cylinder longitudinal axis; said at least one mixture channel opening has an upper edge proximal to said combustion chamber and a lower edge distal from said combustion chamber; a first width of the at least one mixture channel opening, measured at a third spacing of 15% of said at least one mixture channel opening height from the upper edge, is larger than a second width of said at least one mixture channel opening, measured at a fourth spacing of 15% of said at least one mixture channel opening height from said lower edge.

8. The two-stroke engine of claim 7, wherein said at least one mixture channel opening has at least one side wall which interconnects said upper edge and said lower edge; and, said at least one side wall runs straight in a central section, which extends from a spacing of 15% of said at least one mixture channel opening height from said upper edge to a fifth spacing of 15% of said at least one mixture channel opening height from said lower edge.

9. The two-stroke engine of claim 1, wherein said at least one mixture channel opening is mirror symmetrical to a symmetry plane running parallel to a cylinder longitudinal axis.

10. The two-stroke engine of claim 1, wherein said cylinder has an outlet channel which adjoins an outlet opening from the combustion chamber; an outlet channel width of said outlet channel, measured in a sectional plane perpendicular to a cylinder longitudinal axis, proceeding from said outlet opening decreases by at least 25%; and, an outlet channel height of said outlet channel, measured parallel to the cylinder longitudinal axis in a plane containing the cylinder longitudinal axis, proceeding from said outlet opening increases by at least 50%.

11. The two-stroke engine of claim 1, wherein in a position of the two-stroke engine in which a cylinder longitudinal axis is vertical and said crankcase is disposed below said combustion chamber, said at least one mixture channel in said fuel supply unit runs at least partially above said at least one air channel.

12. A handheld work apparatus comprising:
a two-stroke engine including a piston, a cylinder, a crankcase, a crankshaft, and an intake channel;
said cylinder having a cylinder bore in which said piston is mounted so as to reciprocate;
said piston delimiting a combustion chamber formed in said cylinder;
said crankcase defining a crankcase interior;
said crankshaft being mounted in said crankcase so as to be rotatable about a rotational axis and configured to be rotatingly driven by said piston;
said intake channel having a fuel supply unit in which at least one section of said intake channel is formed, said intake channel having an intake channel length;
said intake channel over at least part of said intake channel length being divided into at least one mixture channel and at least one air channel;
said at least one mixture channel opening into said crankcase interior via at least one mixture channel opening;
said two-stroke engine further including at least one transfer channel which in the region of a bottom dead center of said piston fluidically connects said crankcase interior to said combustion chamber;
said at least one transfer channel opens out at said cylinder bore via at least one transfer window;
said at least one air channel opens out at said cylinder bore via at least one air channel opening;
said piston having at least one piston pocket;
wherein said at least one air channel opening, in at least one position of said piston, is connected via said at least one piston pocket to said at least one transfer window of said at least one transfer channel;
wherein when viewed in a direction parallel to the rotational axis of said crankshaft, downstream of said fuel supply unit, said at least one mixture channel and said at least one air channel are formed to be curved over at least one section of a respective length thereof;
said at least one mixture channel, when viewed in the direction parallel to the rotational axis of said crankshaft, downstream of said fuel supply unit up to a first spacing of 5 millimeters from said cylinder bore running exclusively straight or performing a right-hand bend; and,
said at least one air channel, when viewed in the direction parallel to the rotational axis of said crankshaft, downstream of said fuel supply unit up to a second spacing of 10 millimeters from said cylinder bore running exclusively straight or performing a left-hand bend.

13. The handheld work apparatus of claim 12, wherein the work apparatus is a chain saw or an angle grinder.
